(19) United States
(12) Patent Application Publication
(10) Pub. No.: US 2024/0000252 A1
(43) Pub. Date: Jan. 4, 2024

(54) AUTOMATED SEASONING DISPENSER

(71) Applicant: Lab2Fab, LLC, Fremont, CA (US)

(72) Inventors: Samuel Tanaka, San Leandro, CA (US); John Paul Norman, San Jose, CA (US)

(21) Appl. No.: 18/215,226

(22) Filed: Jun. 28, 2023

Related U.S. Application Data
(60) Provisional application No. 63/419,631, filed on Oct. 26, 2022.
(60) Provisional application No. 63/395,677, filed on Aug. 5, 2022.
(60) Provisional application No. 63/356,784, filed on Jun. 29, 2022.

(51) Int. Cl. A47G 19/34; A23P 20/12

(52) U.S. Cl. CPC A47G 19/34; A23P 20/12

(57) ABSTRACT

An automated food processing system provides consumable items to a temporary storage location such as an enclosure of a food processing device. A seasoning dispensing apparatus is located relative to the enclosure to dispense a seasoning over the consumable items within the disclosure. The seasoning dispensing apparatus includes a metering device that provides a discrete seasoning portion for dispensing and a distributor that uniformly dispenses the discrete seasoning portion over the consumable items.

### CROSS-REFERENCE TO RELATED APPLICATIONS

This application claims the benefit of U.S. Provisional Patent Application No. 63/356,784, filed Jun. 29, 2022, and entitled “Robotic Dispensing Mechanism,” U.S. Provisional Patent Application No. 63/395,677, filed Aug. 5, 2022, and entitled “Diffuser for Robotic Dispensing Mechanism,” and U.S. Provisional Patent Application No. 63/419,631, filed Oct. 26, 2022, and entitled “Robotic Dispensing Mechanism,” the disclosures of which are hereby incorporated by reference herein in their entirety.

### BACKGROUND

Robotic automated food preparation systems have been developed for automating various kitchen operations of a restaurant. For example, each of U.S. patent application Ser. No. 17/494,664 (filed on Oct. 5, 2021) and U.S. Provisional Patent Application Ser. No. 63/088,162 (filed on Oct. 6, 2020), each of which is incorporated by reference in its entirety herein, disclose examples of robotic automated food preparation systems that may be used to fry consumable items such as french fries, onion rings, chicken, and other types of food items. Additionally, each of U.S patent application Ser. No. 18/098,437 (filed on Jan. 18, 2023), U.S. Provisional Application Ser. No. 63/300,445 (filed on Jan. 18, 2022), U.S. Provisional Application Ser. No. 63/349,873 (filed on Jun. 7, 2022), and U.S. Provisional Application Ser. No. 63/394,154 (filed on Aug. 1, 2022), each of which is incorporated by reference in its entirety herein, disclose examples of robotic food preparation systems that may be used to guide, move, or distribute various consumable items (e.g., those mentioned above) throughout a cooking process to enable consistent, sterile, and/or automated handling of the consumable items as the consumable items are prepared for consumption (e.g., enabling the safe and consistent handling of recently fried consumable items). There is a continued desire to automate various aspects of food preparation.

### SUMMARY

Example illustrations herein are directed to a seasoning dispensing apparatus that includes a hopper configured to dispense a seasoning, a metering device configured to dispense a discrete seasoning portion from the hopper, and a rotatable distributor configured to spread the discrete seasoning portion received from the metering device radially outwardly from a distributor axis. The dispensing apparatus may include a metering device that is rotatable about a metering axis. The metering axis is offset from the distributor axis. A plurality of pockets may be distributed about a circumference of the metering device. In some embodiments, the metering device of the seasoning dispensing apparatus is arranged above the rotatable distributor.

In some embodiments, the seasoning dispensing apparatus may include a first housing plate configured to interface with the metering device, wherein the first housing plate comprises a metering aperture configured to deliver a discrete seasoning portion to the rotatable distributor. The hopper may be laterally offset from the metering aperture and configured to guide the discrete seasoning portion downward into the metering device by adjusting a trajectory of the discrete seasoning portion laterally with respect to the hopper, such that the discrete seasoning portion is ejected downward from the metering device into the distributor, in response to the trajectory of the discrete seasoning portion being laterally adjusted. The seasoning dispensing apparatus may also include a second housing plate for the rotatable distributor which may define a lateral opening for lateral ejection of the discrete seasoning portion from the distributor.

In some embodiments, the seasoning dispensing apparatus includes at least one securing feature configured to secure the seasoning dispensing apparatus to a food processing device.

In an embodiment of the present disclosure, an automated food preparation system includes a seasoning dispensing apparatus such as described above, as well as a food processing device. The food processing device may include at least one enclosure configured to accommodate consumable items and the at least one enclosure may be coupled to an apparatus configured to regulate a material composition and temperature of air within the at least one enclosure. In some embodiments of the automated food preparation system, the metering device is rotatable about a metering axis, which may be offset from the distributor axis. In some embodiments, the automated food preparation system includes a plurality of pockets distributed about a circumference of the metering device. The metering device may be arranged above the rotatable distributor.

In some embodiments, the automated food preparation system includes a first housing plate configured to interface with the metering device, with first housing plate comprising a metering aperture configured to deliver a discrete seasoning portion to the rotatable distributor. The hopper may be laterally offset from the metering aperture and the hopper configured to guide the discrete seasoning portion downward into the metering device by adjusting a trajectory of the discrete seasoning portion laterally with respect to the hopper, such that the discrete seasoning portion is ejected downward from the metering device into the distributor, in response to the trajectory of the discrete seasoning portion being laterally adjusted. The automated food preparation system may include a second housing plate for the rotatable distributor, wherein the second housing plate defines a lateral opening for lateral ejection of the discrete seasoning portion from the distributor.

In some embodiments, the automated food preparation system includes at least one securing feature configured to secure the seasoning dispensing apparatus to a food processing device.

In an embodiment of the present disclosure, a method of dispensing seasoning includes steps of providing a discrete seasoning portion of seasoning for distribution into a hopper, feeding the discrete seasoning portion to a rotating distributor configured to spread the discrete seasoning portion radially outward from a distributor axis, and expelling the discrete seasoning portion outward from the distributor axis using the rotating distributor. The method may further include steps of reducing a first volume of seasoning to a second volume corresponding to a discrete seasoning portion using a metering device, which may include guiding a portion of seasoning downwards using the hopper, receiving the portion of seasoning at a partitioning wheel, and indexing the portion of seasoning into at least one portion corresponding to the discrete seasoning portion.

In some embodiments, the metering device utilized in the method includes a partitioning wheel. The indexing the portion of seasoning into the at least one portion corresponding to the discrete seasoning portion may include guiding the received portion of seasoning into at least one pocket embedded in a surface of the partitioning wheel, and rotating the partitioning wheel until the at least one pocket receives enough of the portion of seasoning such that the at least one pocket is filled with the second volume of seasoning corresponding to the discrete seasoning portion.

In some embodiments, feeding the discrete seasoning portion to the rotating distributor includes steps of aligning a first pocket of the metering device with a partition arranged below the metering device, and guiding the discrete seasoning portion through the aligned pocket such that the discrete seasoning portion is distributed to a surface of the rotating distributor.

In some embodiments, the rotating distributor used in the method comprises at least one dispensing paddle. Expelling the seasoning outward from the distributor axis may include guiding the discrete seasoning portion towards an origin of the distributor axis and along a surface of the at least one dispensing paddle, and rotating the rotating distributor such that the discrete seasoning portion is guided along the surface of the at least one dispensing paddle towards an outer edge of the at least one dispensing paddle. The rotating distributor may be rotated at a speed corresponding to a width of an opening in a housing plate configured to accommodate the rotating distributor.

In some embodiments, an angle at which the discrete portion of seasoning is expelled is proportional to a speed at which the rotating distributor is rotated. In some embodiments, the steps of the method may further comprise adjusting control parameters of the rotating distributor based on the second volume corresponding to the discrete seasoning portion such that the rotating distributor rotates at a speed corresponding to a target angle.

Example illustrations herein are directed to a diffuser for a seasoning dispensing apparatus having a dispensing opening, where the dispensing opening is configured to eject a particulate seasoning, with the diffuser including a body configured to be positioned adjacent the dispensing opening, with the body at least partially obstructing the dispensing opening to diffuse the particulate seasoning as it is ejected through the dispensing opening. The body may include a plurality of separated obstructions extending across the dispensing opening. The separated obstructions may include elongated bars, and the elongated bars may be elongated in a length direction and define a width in a direction perpendicular to the length of at least one millimeter. In embodiments, the elongated bars may be separated by a spacing of no more than five millimeters or no more than three millimeters. In some embodiments, the separated obstructions include a mesh. In some embodiments, the body obstructs at least 25% of the dispensing opening. In some embodiments, the diffuser may include one or more angled side deflectors defining an oblique angle with respect to an ejection direction of the seasoning through the dispensing opening.

In some embodiments, a diffuser for a seasoning dispensing apparatus having a dispensing opening that is configured to eject a particulate seasoning may include a body configured to be positioned adjacent the dispensing opening, the body at least partially obstructing the dispensing opening to diffuse the particulate seasoning as it is ejected through the dispensing opening, the body including a plurality of elongated bars extending across the dispensing opening and separated by a spacing such that the body obstructs at least 25% of the dispensing opening. The elongated bars may be elongated in a length direction and define a width in a direction perpendicular to the length direction, the width of the elongated bars being at least one millimeter. The elongated bars may be separated by a spacing of no more than three millimeters.

In some embodiments, a seasoning dispensing apparatus comprises a hopper configured to dispense a seasoning, a metering device configured to dispense a discrete seasoning portion from the hopper, a rotatable distributor configured to spread the discrete seasoning portion received from the metering device radially outwardly from a distributor axis through a dispensing opening, and a diffuser having a body positioned adjacent the dispensing opening, the body at least partially obstructing the dispensing opening to diffuse the particulate seasoning as it is ejected through the dispensing opening. The body may include a plurality of separated obstructions extending across the dispensing opening. The separated obstructions may include elongated bars, which may be elongated in a length direction and define a width in a direction perpendicular to the length of at least one millimeter. The elongated bars may be separated by a spacing of no more than five millimeters, or in some embodiments, no more than three millimeters. In some embodiments, the separated obstructions include a mesh. In some embodiments, the body obstructs at least 25% of the dispensing opening. In some embodiments, the seasoning dispensing apparatus also includes one or more angled side deflectors defining an oblique angle with respect to an ejection direction of the seasoning through the dispensing opening.

Example illustrations herein are directed to a seasoning dispensing apparatus that includes a hopper configured to dispense a seasoning, a metering device configured to dispense a discrete seasoning portion from the hopper, and a distributor configured to spread the discrete seasoning portion received from the metering device radially outwardly from a distributor axis. In some embodiments, the distributor may be stationary. The seasoning dispensing apparatus may further include a stationary support configured to suspend the distributor at a predetermined height above an enclosure configured to contain a plurality of consumable items to be seasoned. The enclosure may be configured to regulate a temperature of air within the at least one enclosure.

In some embodiments, the distributor is configured to spread the discrete seasoning portion radially outwardly with a radial spread of 360 degrees from the distributor axis. In some embodiments, the distributor may include a dispersion cone. In some embodiments, the distributor includes a vertex disposed below the metering device, the vertex containing the distributor axis, the distributor including a downwardly angled surface extending radially outwardly from the central portion.

In some embodiments, the metering device includes a portioning plate having a cavity configured to receive the seasoning from the hopper, the cavity defining a volume corresponding to the discrete seasoning portion. The portioning plate may be restricted to a bidirectional movement configured to translate the cavity horizontally with respect to an outlet of the hopper. The seasoning apparatus may further include a stationary cover plate defining an opening, the stationary cover plate positioned above the portioning plate. The seasoning apparatus may further include a linear actuator such as a solenoid configured to translate the portioning plate relative to the hopper.

In some embodiments, the metering device of the seasoning dispensing apparatus is arranged above the distributor. An outlet of the hopper may be aligned with the distributor axis above the distributor. In some embodiments, the seasoning dispensing apparatus includes at least one securing feature configured to secure the seasoning dispensing apparatus to a food processing device. The securing feature may include a magnet.

In some embodiments, an automated food preparation system includes the seasoning dispensing apparatus described above as well as a food processing device. The food processing device may include at least one enclosure configured to accommodate consumable items and wherein the at least one enclosure is coupled to an apparatus configured to regulate a material composition and temperature of air within the at least one enclosure.

In some embodiments, a method of dispensing seasoning may include providing a seasoning in a hopper, feeding a discrete seasoning portion of the seasoning to a distributor, and expelling the discrete seasoning portion with the distributor such that the discrete seasoning portion is spread radially outward from the distributor axis. The step of feeding the discrete seasoning portion to the distributor may include aligning a cavity of a portioning plate of the metering device with an aperture positioned above the distributor, the cavity defining a volume corresponding to the discrete seasoning portion. The steps of the method may further comprise guiding the discrete seasoning portion through the aligned cavity and aperture such that the discrete seasoning portion contacts a surface of the distributor. In some embodiments, the metering device utilized in the method may include a reciprocating portioning plate defining a cavity having an interior volume corresponding to the discrete seasoning portion. In some embodiments, the discrete seasoning portion is distributed from the distributor to a food processing device positioned below the distributor, with the food processing device including at least one enclosure configured to accommodate consumable items, such that the at least one enclosure is coupled to an apparatus configured to regulate a material composition and temperature of air within the at least one enclosure.

### BRIEF DESCRIPTION OF THE DRAWINGS

The above and other objects and advantages of the disclosure may be apparent upon consideration of the following detailed description, taken in conjunction with the accompanying drawings, in which:

FIG. 1 depicts an exemplary automated food preparation system in accordance with some embodiments of the disclosure;

FIG. 2A depicts an exemplary seasoning dispensing apparatus attached to a temporary storage enclosure of an automated food preparation system in accordance with some embodiments of the present disclosure;

FIG. 2B depicts an exemplary seasoning dispensing apparatus in accordance with some embodiments of the present disclosure;

FIG. 2C depicts an exemplary seasoning dispensing apparatus during dispensing in accordance with some embodiments of the present disclosure;

FIG. 2D depicts an exploded view of an exemplary seasoning dispensing apparatus in accordance with some embodiments of the present disclosure;

FIG. 3A depicts exemplary seasoning dispensing in accordance with some embodiments of the present disclosure;

FIG. 3B depicts an exemplary mesh seasoning dispensing diffuser in accordance with some embodiments of the present disclosure;

FIG. 3C depicts an exemplary slotted seasoning dispensing diffuser in accordance with some embodiments of the present disclosure;

FIG. 3D depicts another exemplary view of a slotted seasoning dispensing diffuser in accordance with some embodiments of the present disclosure;

FIG. 4A depicts an exemplary seasoning dispensing apparatus with radial dispensing attached to a temporary storage enclosure of an automated food preparation system in accordance with some embodiments of the present disclosure;

FIG. 4B depicts an exemplary seasoning dispensing apparatus with radial dispensing in accordance with some embodiments of the present disclosure;

FIG. 4C depicts an exemplary seasoning dispensing apparatus with radial dispensing driven by a linear actuator in accordance with some embodiments of the present disclosure;

FIG. 4D depicts a detail view of a dispensing end of an exemplary seasoning dispensing apparatus with radial dispensing in accordance with some embodiments of the present disclosure;

FIG. 4E depicts an exemplary seasoning dispensing apparatus with radial dispensing located above an enclosure and a corresponding dispensing pattern in accordance with some embodiments of the present disclosure; and

FIG. 5 depicts exemplary steps for dispensing seasoning in an automated food preparation system in accordance with some embodiments of the present disclosure.

### DETAILED DESCRIPTION

Example illustrations herein are generally directed to systems and methods that provide automated food preparation (e.g., as executed by at least one automated or robotic apparatus) including application of a seasoning to consumable food items. Example automated systems herein facilitate even and consistent seasoning for each consumable item/batch prepared. A manual seasoning process or existing automated processes, by contrast, generally does not provide a means for even or consistent distribution of seasoning on recently prepared consumable items. The automated food preparation system may include at least one apparatus, station, or subsystem configured to provide consistent and even seasoning of the consumable items. Additionally, the apparatus, station, or subsystem configured to provide consistent and even seasoning of the consumable items may be configured to be incorporated into or otherwise physically and electrically interface with automated food preparation systems and control systems for automated food preparation systems.

Accordingly, example illustrations herein are directed to systems, apparatuses, and methods for automated seasoning of consumable items in a consistent and/or even manner. In some embodiments, the consumable items are prepared using an automated food preparation system. In the examples herein, seasonings may include dry particulate seasonings such as salt, pepper, and/or other dry spices and combinations thereof, although in some embodiments the systems and methods described herein may be utilized for viscous or liquid seasonings, such as via patterned, pressure-fed, or misted seasoning. In one example, the seasoning is salt and is provided for even and/or consistent distribution on French fries or other fried foods. However, examples herein may be applied without limitation to other applications (e.g., wherein the salt is replaced by other herbs, spices, or seasonings and the fries are replaced with any number of other consumable products such as fried chicken tenders, onion rings, other battered/deep fried foods, etc.).

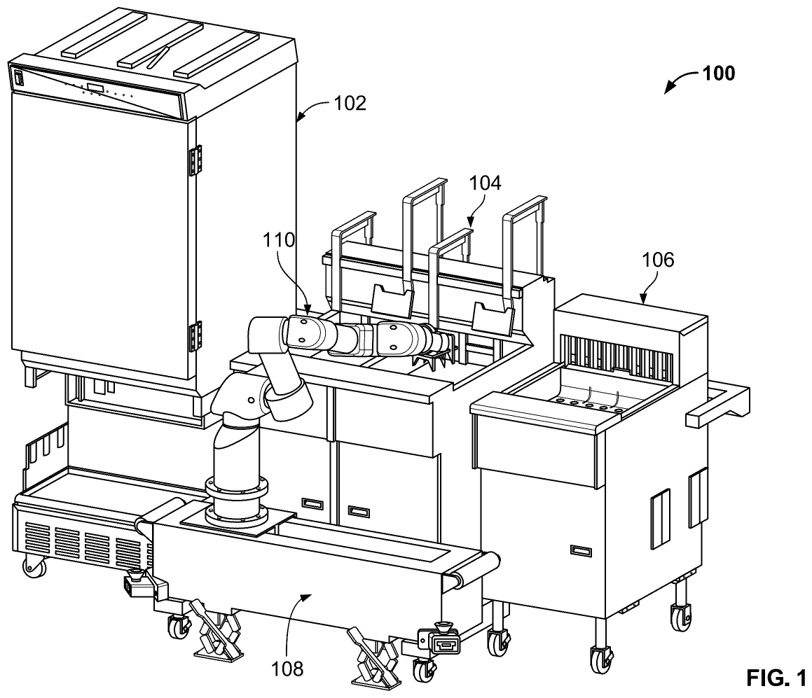

FIG. 1 depicts an exemplary automated food preparation system 100 in accordance with some embodiments of the disclosure. Although the present disclosure applies to seasoning dispensing in the context of a variety of types of automated food preparation system, in an exemplary embodiment the automated food preparation system 100 may be an automated frying system, for example, for frying a variety of types of fried consumable items such as french fries, onion rings, chicken tenders, chicken wings, fried seafood, or any other fried items. Although a variety of components may be included in an automated food preparations system, in the exemplary automated food preparation system 100 of FIG. 1 components may include consumable storage and dispensing equipment 102, fryers 104, temporary storage and finishing area 106, rail 108, and robot arm 110.

Each of the components of the food preparation system may be communicatively coupled (e.g., via one or more wireless or wired communication interfaces) to a control system, which in turn communicates with each of the components or particular physical or logical sub-components thereof, such as sensors, actuators, registers, API interfaces, command interfaces, and the like. In this manner, all of the components of the automated food preparation system 100 may be commonly monitored and controlled by the control system. As will be described herein, an automated seasoning apparatus may be attached to one or more components of automated food preparation system 100, and may similarly be communicatively coupled to the control system for monitoring and control.

In the exemplary embodiment of FIG. 1, the consumable storage and dispensing equipment 102 may store an inventory of consumable items that are selectively dispensed for processing by the food preparation system. The consumable storage and dispensing equipment 102 may maintain the consumable items in suitable conditions (e.g., by refrigerating, freezing, or otherwise controlling temperature and/or humidity or other conditions) and may selectively dispense the consumable items (e.g., in response to a requested order or set of orders, including selections between types of consumable items) in a manner suitable for further processing by other components of the automated food preparation system 100, for example, by performing appropriate operations (e.g., agitating, shaking, separating, or other pre-processing) and providing the consumable item to a component such as a fry basket being held by robot arm 110 located at an appropriate position on rail 108 (e.g., dispensing from a bottom or side location of consumable storage and dispensing equipment 102).

The robot arm 110 may then perform appropriate movements, including in conjunction with lateral movements along rail 108, to position the consumable items in the carrying component (e.g., fry basket) at an appropriate location for further processing, such as a loading location at fryer 104. Fryer 104 may process the consumable item, for example, based on recipes (e.g., temperature profile, cook time, etc.) corresponding to the requested food item. For example, fryer 104 may receive a fry basket at a predetermined loading location and automatically lower the fry basket into the frying position in accordance with the recipe/order. The robot arm 110 and rail 108 may perform additional operations while the consumable item is frying, such as accessing additional dispensed consumable items and providing them to another fryer, moving additional completed consumable items from another fryer to the temporary storage finishing area, moving finished consumable items from the temporary storage and finishing area 106, and the like. In embodiments, the robot arm 110 and rail 108 may be in communication with sensors that identify when an employee is in the area and may cause the robot arm 110 and 108 to operate such that automated system and employee do not interfere with each other, preventing injury and providing for a seamless human-machine interface.

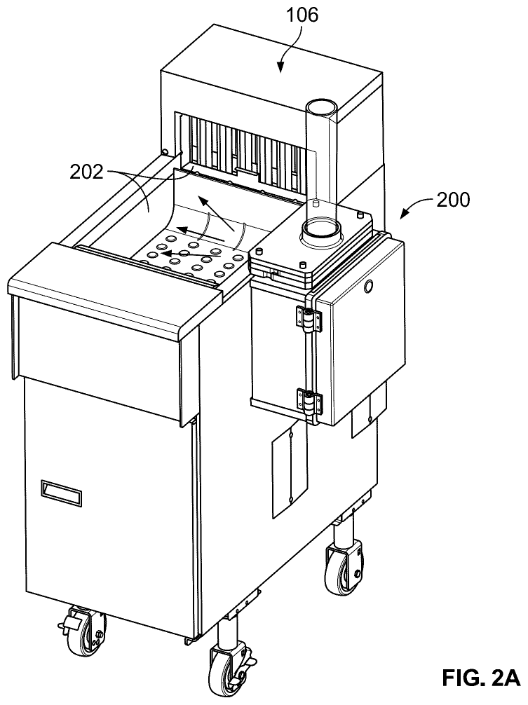

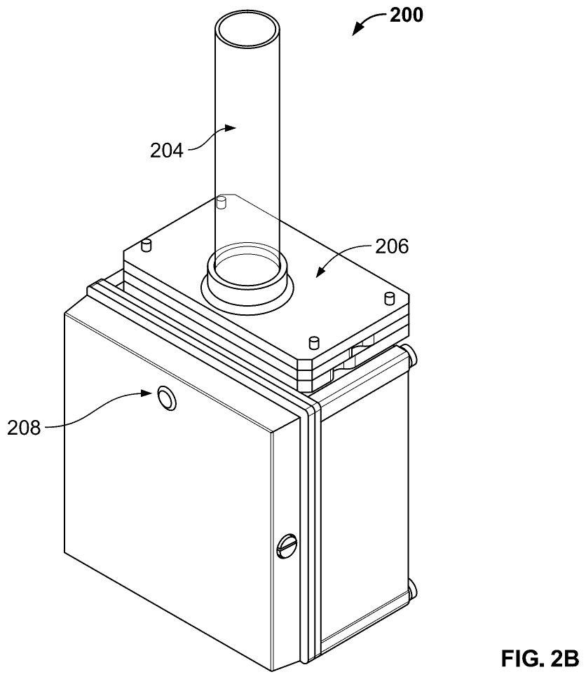

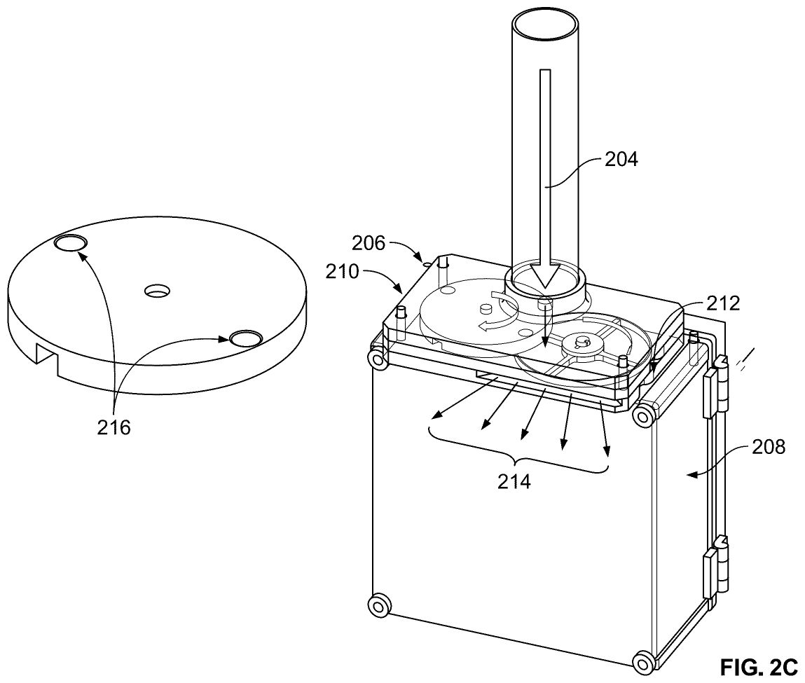

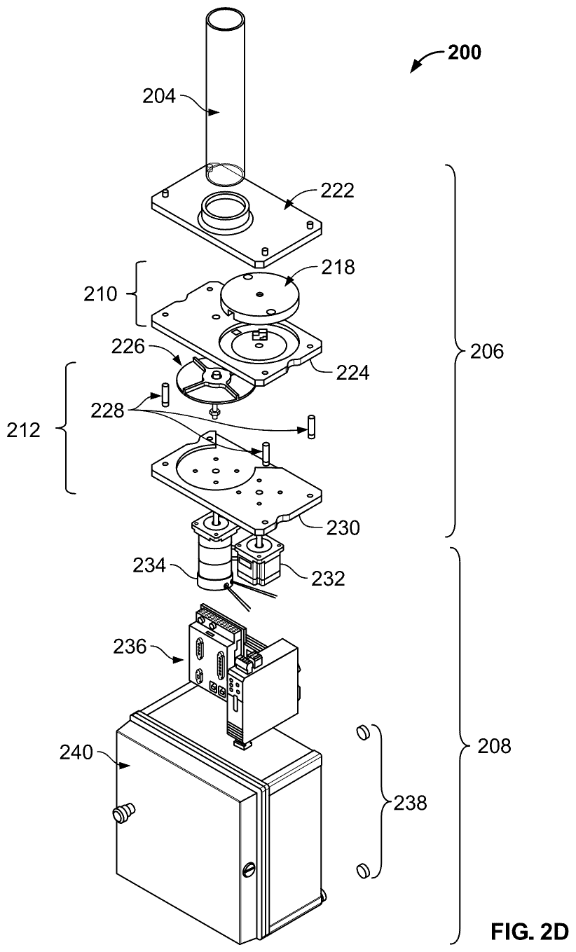

The temporary storage and finishing area 106 may provide a location where the fried or other consumable items may be temporarily stored and where additional operations may be performed on the consumable items, such as application of appropriate seasonings. The temporary storage and finishing area 106 may include an enclosure (e.g., a partially open holding area in some embodiments) that retains the consumable item under appropriate conditions, such as regulating a temperature of the recently fried consumable items. For example, the enclosure may include fans, suction fans, heaters, infrared devices, and the like to maintain an appropriate pressure, moisture level, and temperature such as to prevent steam and/or moisture from accumulating on the consumable items, thus maintaining desirable properties of the consumable items and preventing clumping and clogging of applied seasoning. In some embodiments, an automated seasoning operation may be performed at the enclosure of the temporary storage and finishing area 106, as depicted in FIG. 2A. Providing automated seasoning may provide substantial advantages over manual seasoning or partially automated seasoning operations, for example, by reducing the likelihood of physical interaction of employees and automated equipment or high-temperature equipment and consumable items, ensuring consistency of seasoning application, ensuring appropriate timing of application of seasoning, and the like. Although automated seasoning may be described herein in the context of applying the seasoning at the finishing area 106, it will be understood that automated seasoning operations may be performed during other stages of operation as appropriate, such as after dispensing or during frying, by appropriately locating an automated seasoning apparatus relative to other components of the automated food preparations system.

FIG. 2A depicts an exemplary seasoning dispensing apparatus 200 attached to an enclosure 202 of a temporary storage and finishing area 106 of an automated food preparation system, in accordance with some embodiments of the present disclosure. In at least some examples, the temporary storage and finishing area 106 (e.g., a food processing device) comprises at least one enclosure 202 configured to accommodate consumable items (e.g., received from a fryer via a robot arm manipulating a fry basket). For example, an enclosure 202 may be coupled to an apparatus (e.g., of finishing area 106) configured to regulate a material composition and temperature of air within the at least one enclosure (e.g., a device configured to enable processing and seasoning of consumable items within an at least partially enclosed area). The enclosure 202, and other enclosures described herein, may include fans, suction fans, heaters, infrared devices, and the like to maintain an appropriate pressure, moisture level, and temperature such as to prevent steam and/or moisture from accumulating on the consumable items, thus maintaining desirable properties of the consumable items and preventing clumping and clogging of applied seasoning.

A seasoning dispensing apparatus may be coupled (e.g., fixedly or removably attached) to the temporary storage and finishing area 106 such that when consumable items have completed a frying cycle and are delivered to a holding or temporary storage area such as enclosure 202, the seasoning for the consumable items may be applied to the consumable items in a controlled an automated manner using the seasoning apparatus 200. As depicted by the arrows in FIG. 2A, the seasoning may be dispensed from the seasoning dispensing apparatus 200 over the consumable items in the enclosure 202, in a manner that distributes the seasoning in a uniform or other desired manner. In some embodiments, a component of the finishing area may coordinate additional automated operations with the seasoning dispensing, such as by shaking, agitating, rotating, shifting, or otherwise moving the consumable item while the seasoning operation is being performed and/or in stages between seasoning operations.

The seasoning dispensing apparatus may be communicatively coupled to the control system, such as through a wireless or wired connection (not depicted). In this manner, the operations of the seasoning dispensing apparatus may be monitored and controlled such that operations of the seasoning dispensing apparatus may be coordinated with other components of the automated food preparation system such as a robot arm that places fried consumable items into an enclosure of a finishing area and/or other operations performed by the finishing station. In some embodiments, the seasoning dispensing apparatus may include sensors (not depicted) that monitor components of the seasoning distribution apparatus (e.g., a mass or volume of seasoning within a hopper, torque required for motors, motor current, etc.) or the environment of the seasoning dispensing apparatus (e.g., presence or heat sensors to detect the presence of consumable items). In some embodiments, such sensors may be located on other components, such as a temporary storage and finishing area 106 that a seasoning distribution apparatus attaches with during operation.

FIG. 2B depicts an exemplary seasoning dispensing apparatus in accordance with some embodiments of the present disclosure. A seasoning dispensing apparatus 200 includes a hopper 204 configured to hold and feed a seasoning, a metering and dispensing device 206 including a metering device configured to dispense a discrete seasoning portion from the hopper 204 and a dispensing device to rotatably distribute the seasoning received from the metering device radially outwardly (not shown in FIG. 2B) from a distributor axis paired, coupled, or interfacing with the enclosure of the finishing area. Electromechanical equipment for controlling the hopper, metering device, dispensing device, and other components of the seasoning dispensing apparatus may be located within a cabinet 208, which may be connected to local utilities (e.g., electricity) via direct connection and/or connection via coupling to other components of the automated food processing system (not depicted) such as temporary storage and finishing area 106. In the embodiment depicted in FIG. 2B, a single hopper 204 provides a source of a single type of seasoning (e.g., including combinations of seasonings). In some embodiments, the dispensation of multiple seasonings to match different recipes and/or consumable items may be facilitated by different hopper 204 configurations (not depicted), such as multi-compartment (e.g., pie piece) hoppers 204 or automatically interchangeable hoppers 204 (e.g., that seal during removal and are automatically displaced by another similarly shaped hopper including different seasoning(s)).

FIG. 2C depicts an exemplary seasoning dispensing apparatus 200 during dispensing in accordance with some embodiments of the present disclosure. Seasoning dispensing apparatus 200 includes a hopper 204 configured to feed a seasoning for dispensing 214 via a metering device 210 of a metering and dispensing device 206, and a rotatable distributor 212 of a metering and dispensing device 206 configured to dispense and spread the discrete seasoning portion received from the metering device radially outwardly from a distributor axis in a dispensing operation 214.

A first volume corresponding to a distribution portion of seasoning may be reduced to a second volume corresponding to a discrete seasoning portion using the metering device 210. A distribution portion of seasoning may be guided downwards using the hopper 204 and received via the metering device 210 and processed thereby with a partitioning wheel 218 such that the discrete seasoning portion is received adjacent to paddles of a rotatable distributor 212, such that the discreate seasoning portion is indexed within a portion of the distributor 212 for distribution via dispensing operation 214.

In some embodiments, the metering device 210 and distributor 212 are laterally offset from each other. For example, the partitioning wheel 218 of metering device 210 may be rotatable about a metering axis corresponding to the center axis of the metering device 210 about which the metering device 210 rotates, with the metering axis being offset from an axis of rotation of the distributor 212, which is located at a center point of the distributor 212 about which a disk of distributor 212 rotates. Additionally, a plurality of pockets 216 may be distributed about a circumference of partitioning wheel 218 of the metering device 210. The pockets 216 may be distributed in a variety of suitable locations and may have different shapes and sizes as appropriate, based for example of the amount of seasoning, type of seasoning (e.g., separate locations for different seasonings), relative location of partitions of the partitioning wheel, and the like. The metering device 210 may be arranged above the rotatable distributor 212. The metering device 210 may generally drop discrete portions of a seasoning into the distributor 212 via pockets 216 of partitioning wheel 218, with the distributor spreading or otherwise applying the seasoning to consumable items via an opening in the in the metering and distributing device 206 adjacent to and in communication with the distributor 212.

FIG. 2D depicts an exploded view of an exemplary seasoning dispensing apparatus 200 in accordance with some embodiments of the present disclosure. In some embodiments, the metering device 210 of the metering and distributing device 206 of the apparatus 200 includes a first housing plate 224 configured to interface with the partitioning wheel 218 of metering device 210, wherein the first housing plate 224 comprises a metering aperture (e.g., an opening of the first housing plate located below the partitioning wheel 218) configured to deliver a discrete seasoning portion to the rotatable distributor 212. Additionally, the apparatus 200 may further comprise a second housing plate 230 for a paddle wheel 226 of the rotatable distributor 212. In some embodiments, feeding the discrete seasoning portion to the rotatable distributor 212 includes steps of aligning a pockets of partitioning wheel 218 of metering device 210 with a particular portion or partition of the paddle wheel 226 of the distributor 212. In some embodiments, the paddle wheel 226 of distributor 212 includes at least one dispensing paddle, configured as ridges that extend outward from a center point of paddle wheel 226, although other shapes and patterns may be utilized in other embodiments. Expelling the seasoning outward from the distributor axis may include guiding the discrete seasoning portion towards an origin of the paddle wheel 226 of the rotatable distributor 212 axis and along a surface of the at least one dispensing paddle and rotating the paddle wheel 226 of distributor 212 such that the discrete seasoning portion is guided along the surface of the at least one dispensing paddle towards an outer edge of the at least one dispensing paddle. The rotating distributor may be rotated at a speed corresponding to a width of an opening in housing plate 230 configured to accommodate the rotating distributor.

Locating pins 228 may fixedly locate the first housing plate 224 (including partitioning wheel 218), second housing plate 230 (including paddle wheel 226), and hopper housing plate 222 with respect to each other. The second housing plate 230 may define a lateral opening for lateral ejection of the discrete seasoning portion from the distributor 212, e.g., via rotation of the paddle wheel 226 of rotatable distributor 212. Accordingly, an overall rate of seasoning distributed by the distributor may generally be a function of a size of the seasoning portion delivered to the distributor and a rate of rotation for dispensing of the seasoning portions. An angle at which the discrete portion of seasoning is expelled may be proportional to a speed at which the paddle wheel 226 of the rotatable distributor 212 is rotated. In some embodiments, control parameters of the rotating distributor may be adjusted based on the paddle wheel 226 of the rotatable distributor 212 rotating at a speed corresponding to a target angle. In at least some examples, the discrete portion of seasoning is relatively small, and the rotational speed of the distributor and angle of ejection are such that the seasoning is evenly distributed in a target area (e.g., corresponding to consumable items being seasoned by the rotatable distributor 212).

In some embodiments, the hopper 204 is laterally offset from the metering aperture via a locating of a hopper housing plate 222, for example, by relative location via locating pins 228. The hopper 204 may be configured to store bulk seasoning for loading into the apparatus for dispensing. The hopper 204 may have a cap or lid (not shown) to keep out contaminants, moisture, etc. Additionally, the hopper 204 is configured to guide the discrete seasoning portion downward into the metering device by adjusting a trajectory of the discrete seasoning portion laterally with respect to the hopper 204. The discrete seasoning portion may be received at the metering device 210 from the hopper 204, laterally shifted via rotation of the partitioning wheel 218 of the metering device 210, and ejected downward from the metering device 210 into paddle wheel 226 of the rotatable distributor 212. Accordingly, in at least some examples the seasoning portion is laterally shifted from the hopper to the rotatable distributor 212 via the metering device 210.

The seasoning dispensing apparatus 206 may also include at least one securing feature 238 configured to secure the seasoning dispensing apparatus 200 to a food processing device, e.g., to a temporary storage and finishing area 106. For example, the securing feature 238 may be a magnet, a fastener, or another securing assembly configured to facilitate a concise assembly of the apparatus with an automated food preparation system and simple or quick removal of the apparatus from the automated food preparation system. In some embodiments, not depicted in FIGS. 2A-2D, utility connections such as a connection to electricity may be made by an interface between the seasoning dispensing apparatus 200 and the attached food processing device.

In some embodiments, at least one of a manual dispense button, a dispensing knob, or a control adjustment panel may be incorporated to enable start, control, and adjustment of the dispensing of seasoning poured into the hopper. In other examples, the apparatus may be remotely or electronically controlled, for example, by a control system in coordination with other components of an automated food preparation system.

In some embodiments, the apparatus may comprise locating pins 228 for arranging at least one housing plate 222, a metering device 210, and rotatable distributor 212 with respect to each other. Arranged below the metering and distribution device 206 are motors 232 and 234, which receive electricity and are controlled via executable instructions from a control and power supply 236 arranged to be operated (e.g., by a control system of the automated food preparation system and/or manually by a button, or control adjuster arranged external to an enclosure 240 of cabinet 208 corresponding to a housing or mounting base of the apparatus 200). In some embodiments, not depicted in FIGS. 2A-2D, processing circuitry such as microprocessors or other computing or processing units may be included within the seasoning dispensing apparatus to control operations thereof, for example, based on instructions and commands received via a communication interface (not depicted) in communication with a control system of the automated food processing system. In some embodiments, the seasoning dispensing apparatus may include a user interface such as a touch screen or microphone to receive user input, such as via selection or voice commands. In some embodiments, one or more sensors (not depicted) may be included within the seasoning dispensing apparatus, such as temperature sensors, current sensors (e.g., associated with motor torque), proximity sensors, moisture sensors, humidity sensors, level sensors, and the like.

Each of the motors 232 and 234 is associated with a respective offset axis of one of the partitioning wheel 218 and paddle wheel 226 of either the metering device 210 or distributor 212. In some embodiments, not depicted in FIGS. 2A-2D, other forms of transferring rotational force to the respective partitioning wheel 218 and paddle wheel 226 may be utilized, such as having a single motor and gearing or other force transfer mechanisms (e.g., pulleys) between the central axes of the disk and wheel.

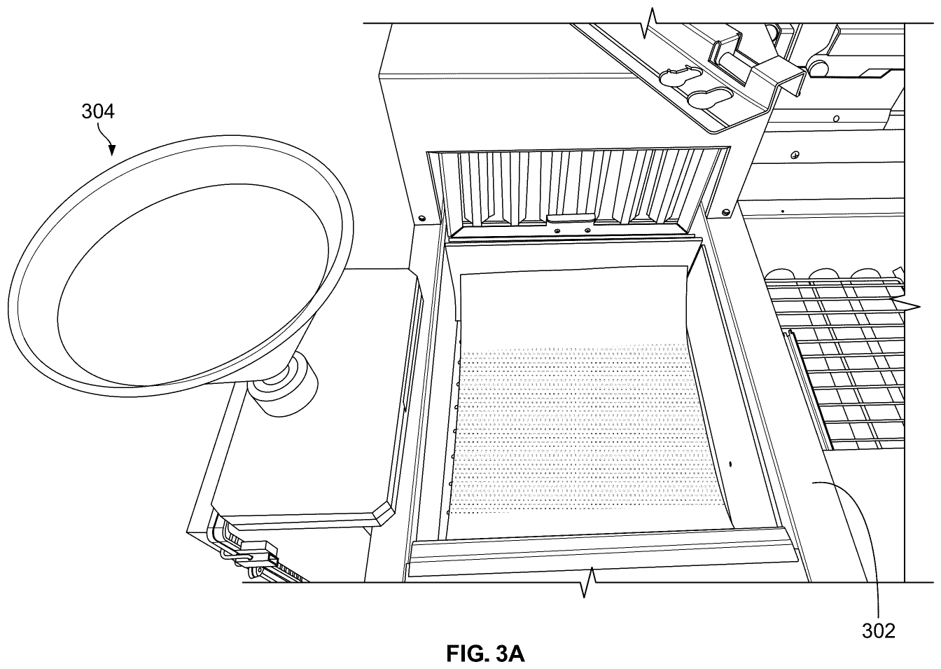

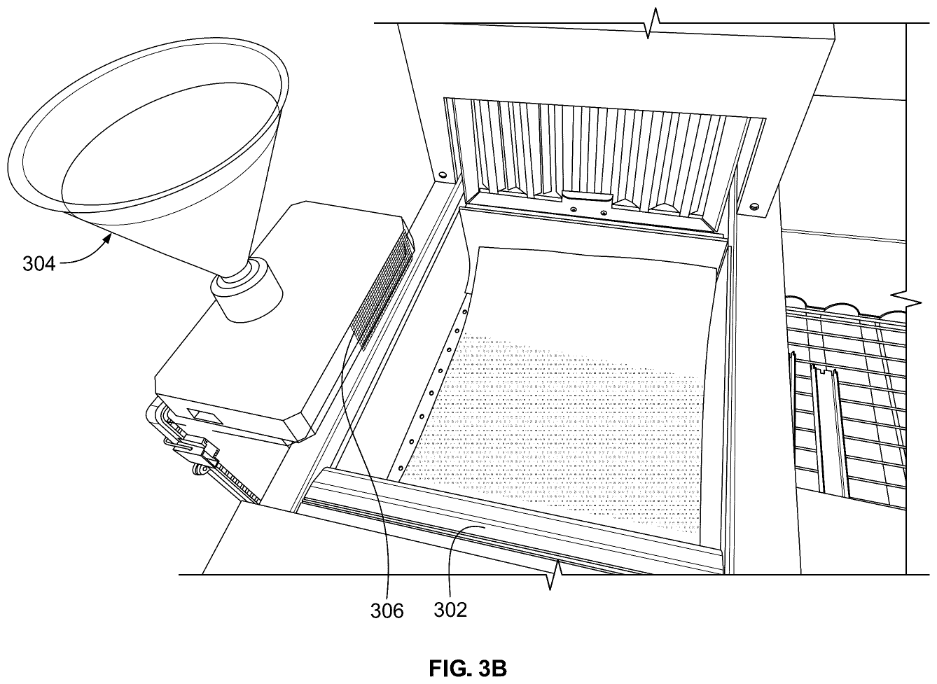

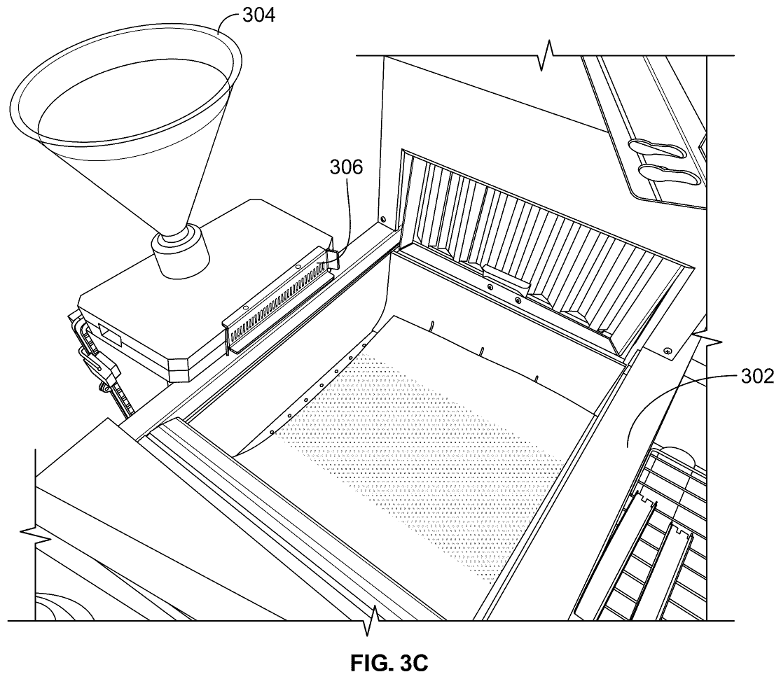

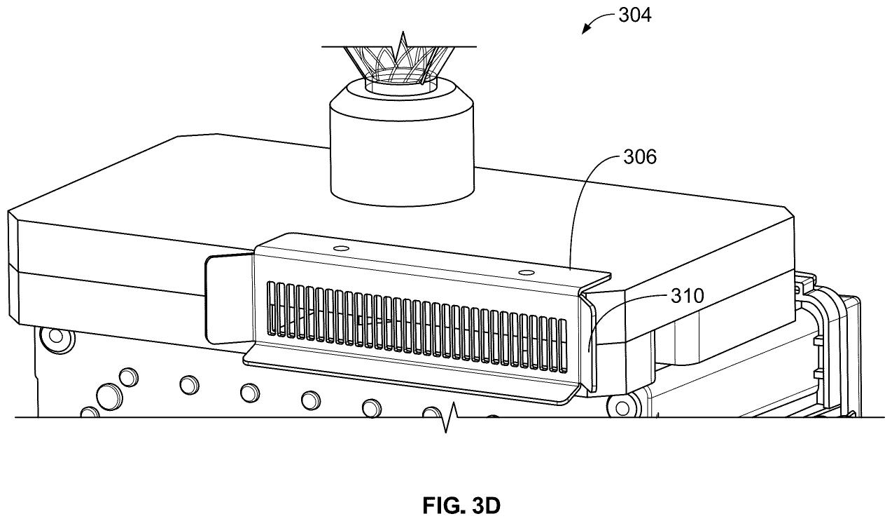

FIG. 3A depicts exemplary seasoning dispensing in accordance with some embodiments of the present disclosure. In an embodiment, a seasoning dispensing apparatus 304 may be a seasoning dispensing apparatus as described herein, e.g., including a hopper, metering device, and distributor to distribute a discrete amount of seasoning laterally in a particular direction. An enclosure 302 may temporarily store and provide other processing (e.g., heating, crisping, etc.) to a consumable item and the seasoning dispensing apparatus 304 may be located adjacent (e.g., via attachment) to the enclosure 302 such that the dispensing of seasoning is provided laterally from an opening of the seasoning dispensing apparatus 304 in the direction of the consumable items (not depicted) within the disclosure. As can be seen by the dispensed seasoning within the enclosure 302, in some implementations the dispensed seasoning may not dispense evenly into the enclosure.

In some embodiments, one or more seasoning diffusers may facilitate even dispensing of seasoning from an automated dispensing device seasoning dispensing apparatus 304. Diffuser sizes, patterns, location, shapes, and the like may be selected based on system parameters (e.g., enclosure size, consumable items being processed, type of automated dispenser) and seasoning types (e.g., size, weight, etc.) to ensure even distribution. In some embodiments, diffusers may be automatically substituted during system operation, for example, based on different consumable items and/or seasonings. The diffuser includes a body configured to be positioned adjacent the dispensing opening, with the body at least partially obstructing the dispensing opening to diffuse the particulate seasoning as it is ejected through the dispensing opening. The body may include a plurality of separated obstructions extending across the dispensing opening. The body at least partially obstructs the dispensing opening to diffuse the particulate seasoning as it is ejected through the dispensing opening. Accordingly, the seasoning may be more evenly distributed across consumable food item(s) adjacent and below the dispensing opening. Example obstructions may be provided by way of a mesh, grate, or other obstructions that at least partially obstruct the dispensing opening.

FIG. 3B depicts an exemplary mesh seasoning dispensing diffuser in accordance with some embodiments of the present disclosure. Mesh diffuser 306 may be positioned adjacent a dispensing opening or other ejection location of seasoning dispensing apparatus 304 for seasoning. The mesh diffuser 306 generally may facilitate even distribution of a particulate seasoning by at least partially obstructing the seasoning as it is propelled out of the dispensing opening. In the instance of a mesh diffuser, the ejection may tend to force the seasoning to exit the mesh along both the length and the height of the mesh, with similar quantities of seasoning thus being ejected at different heights and lateral locations. Accordingly, the seasoning is prevented from overshooting consumable items being seasoned or from collecting at one end of the basket/tray holding the consumable items. An exemplary pattern of seasoning distribution within an enclosure 302 in accordance with a mesh diffuser 306 is depicted in FIG. 3B.

FIG. 3C depicts an exemplary slotted seasoning dispensing diffuser in accordance with some embodiments of the present disclosure, while FIG. 3D depicts another view of an exemplary slotted seasoning dispensing diffuser in accordance with some embodiments of the present disclosure. As depicted in FIG. 3C, in the slotted diffuser 306 the separated obstructions may include elongated bars, and the elongated bars may be elongated in a length direction and define a width in a direction perpendicular to the length of at least one millimeter. The width of the bars (i.e., in a direction perpendicular to that of their elongation) relative to a spacing between the bars may be set according to a desired seasoning and distribution pattern desired. In an example illustrated in the appended drawings, bars having a width of at least one (1) millimeters are spaced apart by, merely as examples, three (3) millimeters or, in another example, five (5) millimeters. In the 3 mm spacing example, the diffuser essentially obstructs 25% of the aperture of the distribution apparatus. Other example percentages may be employed, for example to be tuned to the desired distribution area.

As depicted in FIG. 3D, in some embodiments, the diffuser may include one or more angled side deflectors 310 defining an oblique angle with respect to an ejection direction of the seasoning through the dispensing opening of the seasoning dispensing apparatus 304. Other shapes and/or angles of deflectors may be provided in other installations, for example, depending on the respective configuration and location of the dispensing opening and consumable item location, the angle and speed of dispensing, and the like. For example, a deflector 310 or a portion thereof may be partially curved inward. Further, a deflector 310 may be located at additional locations, such as above or below the dispensing opening.

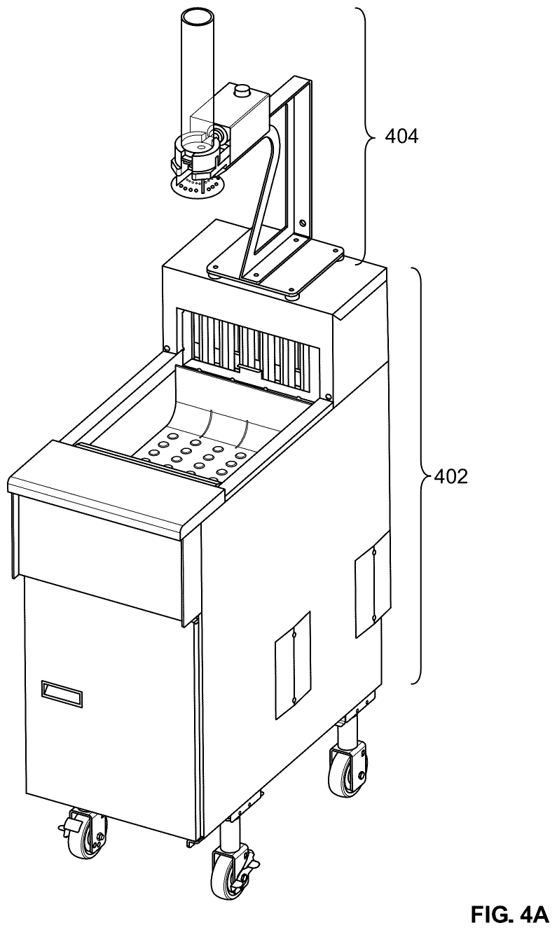

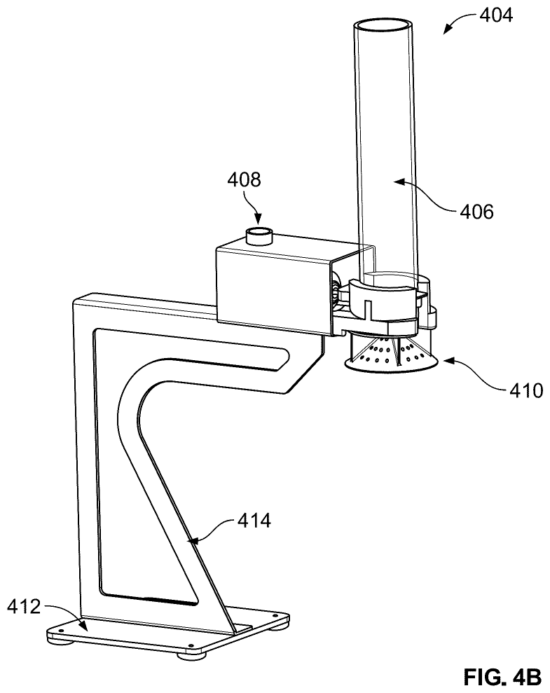

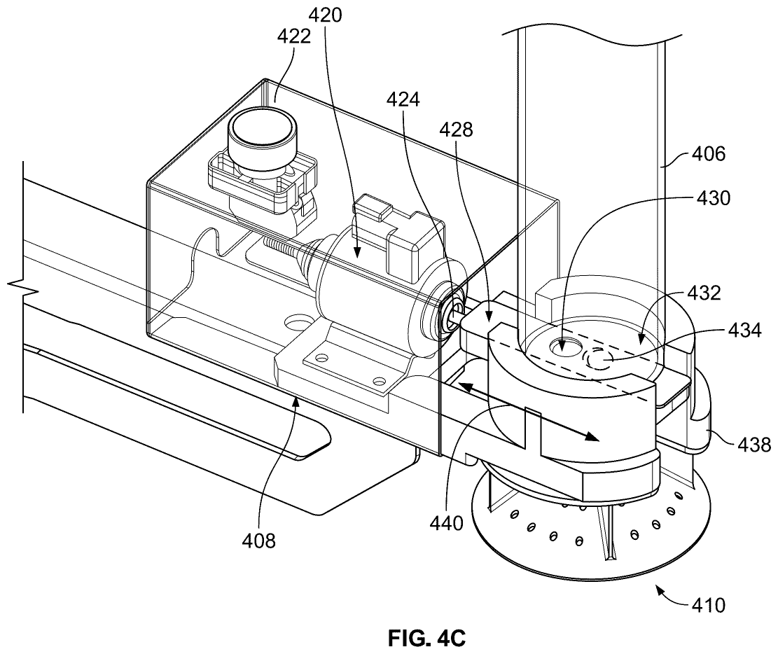

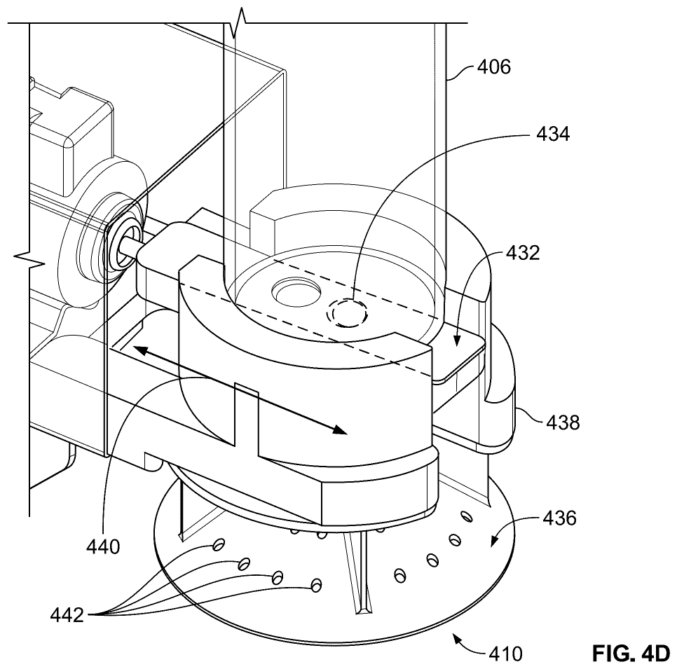

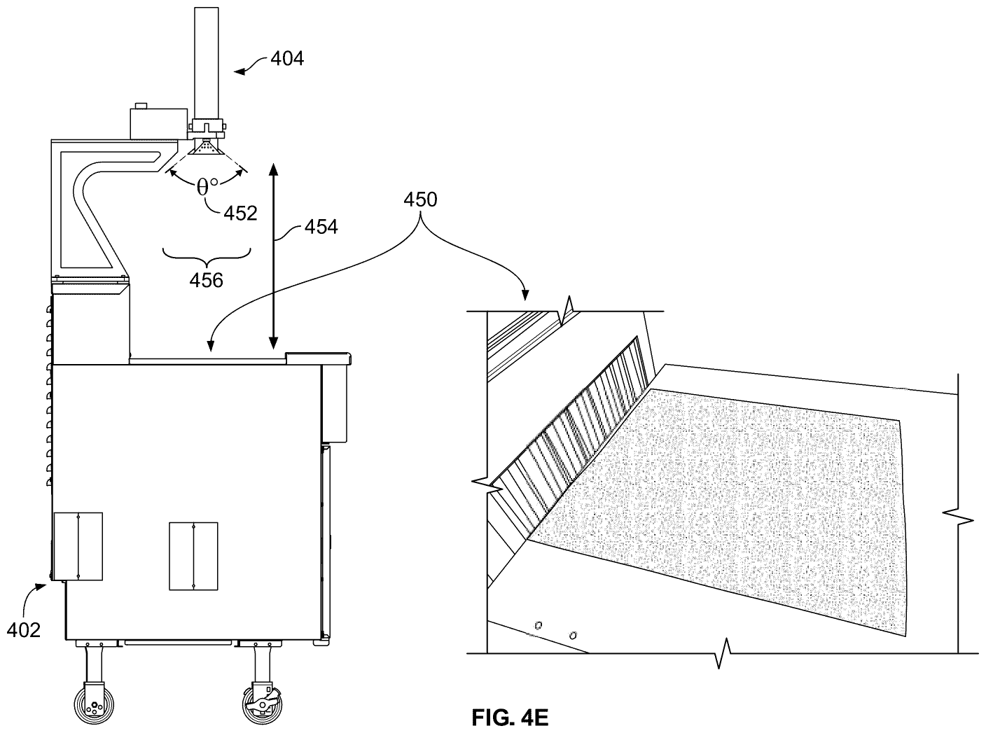

FIG. 4A depicts an exemplary seasoning dispensing apparatus with radial dispensing attached to a temporary storage enclosure of an automated food preparation system in accordance with some embodiments of the present disclosure. The illustrated example embodiment is generally directed to a seasoning dispensing apparatus comprising a hopper configured to dispense a seasoning, a metering device configured to dispense a discrete seasoning portion from the hopper, and a distributor configured to spread the discrete seasoning portion received from the metering device radially outwardly from a distributor axis. In some embodiments, an automated food preparation system includes the seasoning dispensing apparatus 404 above as well as a food processing device 402 (e.g., a temporary storage and finishing area including an enclosure for consumable items). The food processing device 402 may include at least one enclosure configured to accommodate consumable items with the at least one enclosure coupled to an apparatus configured to regulate a material composition and temperature of air within the at least one enclosure. For example, the enclosure may be a “crisp-n-hold” that is configured to regulate a temperature of air within the at least one enclosure, e.g., to keep food contained within the enclosure warm. The enclosure may include fans, suction fans, heaters, infrared devices, and the like to maintain an appropriate pressure, moisture level, and temperature such as to prevent steam and/or moisture from accumulating on the consumable items, thus maintaining desirable properties of the consumable items and preventing clumping and clogging of applied seasoning.

A fryer (not shown) may be arranged towards a final station of an automated food processing system to provide the consumable items to the enclosure of the food processing device 402. The seasoning dispensing apparatus 404 is coupled to the food processing device 402 adjacent to the enclosure such that when consumable items have completed a frying cycle and are delivered to a holding or temporary storage area, e.g., comprising the enclosure below the distributor, the seasoning may be applied to the consumable items in a controlled and/or automated manner using the seasoning apparatus.

FIG. 4B depicts an exemplary seasoning dispensing apparatus 404 with radial dispensing in accordance with some embodiments of the present disclosure. In the exemplary seasoning dispensing apparatus 404 of FIGS. 4A-4E, a hopper 406 is configured to provide seasoning (e.g., via a gravity feed) and a metering device 408 is configured to meter a discrete seasoning portion from the hopper 406. The seasoning dispensing apparatus 404 also includes a distributor 410 that receives the discrete seasoning portion and spreads the discrete seasoning portion received from the metering device 408 down and radially outwardly about a center distributor axis.

In the examples illustrated, the distributor 410 remains generally stationary and is positioned below the metering device 408 and hopper 406. The seasoning dispensing apparatus 404 may include a stationary support 414 (e.g., a riser bracket) physically coupled to between the functional dispensing components (e.g., hopper 406, metering device 408, and distributor 410) and a securing feature 412 to suspend the distributor at a predetermined height above an enclosure of a food processing device 402 (not depicted in FIG. 4B) that contains the consumable items to be seasoned. The stationary support 414 is provided with a securing feature 412 that secures the seasoning dispensing apparatus to a food processing device, such as via magnetic attachment as depicted or other securing mechanisms such as bolts, pins, or the like. For example, one or more magnets of the securing feature may hold the riser bracket (and as a result, the distributor) in a fixed position above the food processing device.

The seasoning dispensing apparatus 404 may be communicatively coupled to the control system, such as through a wireless or wired connection (not depicted). In this manner, the operations of the seasoning dispensing apparatus may be monitored and controlled such that operations of the seasoning dispensing apparatus 404 may be coordinated with other components of the automated food preparation system such as a robot arm that places fried consumable items into an enclosure of a food processing device 402 (e.g., a finishing area). In some embodiments, the seasoning dispensing apparatus 404 may include sensors (not depicted) that monitor components of the seasoning distribution apparatus (e.g., a mass or volume of seasoning within a hopper, torque required for motors, electrical current, etc.) or the environment of the seasoning dispensing apparatus (e.g., presence or heat sensors to detect the presence of consumable items). In some embodiments, such sensors may be located on other components, such as a finishing are that a seasoning distribution apparatus attaches with during operation.

The seasoning dispensing apparatus 404 includes a hopper 406 that holds and provides seasoning for dispensing, for example, via a gravity feed. Although hopper 406 is depicted as a single cylinder for holding the seasoning, in embodiments the hopper 406 may have different shapes. In some embodiments, not depicted in FIGS. 4A-4E, a hopper may include multiple portions with different seasonings for selective dispensing, or multiple hoppers may automatically be sealed and moved over the metering device 408 for metered dispensing. A metering device 408 is located below hopper 406 and selectively portions and provides a discrete seasoning portion from the hopper 404 to a distributor 410, which in turn spreads the discrete seasoning portion received from the metering device 408 radially down and outwardly about a distributor axis. In some embodiments, the distributor 410 may be stationary. The enclosure may be configured to regulate a temperature of air within the at least one enclosure.

FIG. 4C depicts an exemplary seasoning dispensing apparatus with radial dispensing driven by a linear actuator in accordance with some embodiments of the present disclosure. The metering device 408 may include a portioning plate 428 having a cavity 434 that receives the seasoning from the hopper 406, which is positioned above the metering device 408. The cavity 434 may be a hole or channel extending entirely through the portioning plate 428. Further, a cover plate 432 may be positioned above the portioning plate 428, and the cover plate 432 may have an opening 430 such that when the cavity 434 of the portioning plate 428 is aligned with the opening 430 of the cover plate 432, the cavity 434 is free to receive the seasoning from the hopper 406 via the opening 430. The amount of seasoning delivered to the cavity in a single discrete seasoning portion may thereby generally be limited by the volume of the cavity 434, and as such the volume may be selected to correspond to a desired amount of seasoning for each discrete portion. An indexing arm 424 may be connected to the portioning plate 428, which is actuated by a linear actuator such as solenoid 420. A reciprocating motion of the portioning plate 428 imparted by the solenoid 420 may cause the cavity 434 to translate horizontally, moving the portioning plate 428 underneath the cover plate 432 such that the cavity 434 is of the portioning plate 428 is no longer aligned with the opening 430 of the cover plate 432. In this manner, additional seasoning is preventing from entering the cavity 434 of the portioning plate 428 from the hopper 406. Further, the movement of the portioning plate 428 may cause the cavity 434 to be aligned with an aperture (not depicted) of fixture 438 below the portioning plate 428, allowing the seasoning in the cavity to be dropped downward through the portioning plate 428 and onto the distributor 410. Accordingly, the entire discrete seasoning portion may fall out of the cavity 434 onto the distributor when the portioning plate 428 is positioned over the aperture. The portioning plate 428 may subsequently move back to a position such that the cavity 434 is aligned with opening 430, thereby receiving the next amount of seasoning in the cavity 434 from the hopper 406. Accordingly, the portioning plate 428 may generally be restricted to a bidirectional movement configured to translate the cavity 434 horizontally with respect to the hopper 406 and distributor 410.

The outlet of the hopper 406 may be aligned with a distributor axis and/or vertex of the distributor 410, and as such the discrete seasoning portion may generally be spread radially outwardly from the distributor axis in an even manner by the distributor 410 to the food processing device 402 below (not depicted in FIG. 4C). Additionally, a plurality of vertically extending dividers may be provided on the distributor 410 to promote more even radial spreading of the discrete seasoning portion. In some embodiments, the distributor may also rotate, facilitating the movement of the seasoning over and through the distributor, and the dispersion of the seasoning from the distributor. For example, the distributor 410 may be coupled to the motion of the solenoid via gears and/or pulleys to rotate, oscillate, and or vibrate to assist with dispersion.

In some embodiments, not depicted in FIGS. 4A-4E, processing circuitry such as microprocessors or other computing or processing units may be included within the seasoning dispensing apparatus (e.g., within the metering device 408) to control operations thereof, for example, based on instructions and commands received via a communication interface (not depicted) in communication with a control system of the automated food processing system. In some embodiments, one or more sensors (not depicted) may be included within the seasoning dispensing apparatus, such as temperature sensors, current sensors (e.g., associated with motor torque), proximity sensors, moisture sensors, humidity sensors, level sensors, and the like. In an example, the metering device 408 may also be manually actuated, e.g., with a button 422.

FIG. 4D depicts a detail view of a dispensing end of an exemplary seasoning dispensing apparatus with radial dispensing in accordance with some embodiments of the present disclosure. The distributor 410 is illustrated as a generally cone-shaped distributor with a plurality of perforations or apertures 442, and as such a granular seasoning, e.g., salt, pepper, or the like, may be distributed to the food processing device below by sliding down the downwardly angled surfaces of the distributor, with some percentage of the seasoning falling through the apertures constituting the perforation of the downwardly angled surface. A number of perforations 442, spacing of the perforations 442, and relative size of the perforations 442 may be selected to evenly distribute seasoning to the food processing device 402 below the distributor 404.

The distributor 410 may define a cone shape 436 configured to allow a discrete seasoning portion received upon the distributor/cone to slide radially outwardly from the distributor axis. The dispersion cone or distributor may thereby spread the discrete seasoning portion radially outwardly with a radial spread of 360 degrees from the distributor axis. While the foregoing examples generally illustrate a cone-shaped distributor, in other example approaches a distributor may be employed having a different shape and/or configuration. Merely by way of example, one or more angled planes, surface, or the like may be provided to radially spread the discrete seasoning portion to food items positioned below the metering device.

In some embodiments, the distributor 410 is configured to spread the discrete seasoning portion radially outwardly with a radial spread of 360 degrees from the distributor axis. In some embodiments, the distributor 410 may include a dispersion cone 436. In some embodiments, the distributor 410 includes a vertex disposed below the metering device 408, the vertex containing the distributor axis, the distributor 410 including a downwardly angled surface extending radially outwardly from the central portion. The vertex may be aligned with a discrete seasoning portion as it is delivered to the distributor 410, thereby spreading the discrete seasoning portion radially outwardly from the distributor axis. The distributor/cone 410 may define a downwardly angled surface extending radially outwardly from the central portion. In these examples, as the metering device 408 delivers a discrete seasoning portion to the vertex of the distributor 410, the seasoning portion, e.g., salt, pepper, or other granular seasoning, generally slides down the angled surface away from the vertex, being spread radially away from the distributor axis.

FIG. 4E depicts an exemplary seasoning dispensing apparatus 404 with radial dispensing located above an enclosure 450 of a food processing device 402 and a corresponding dispensing pattern in accordance with some embodiments of the present disclosure. A height 454 of the distributor of the seasoning dispensing apparatus above the food processing device, a width 456 of the distributor, and an angle 452 of the distributor surface may also generally dictate the degree to which the discrete seasoning portion is evenly spread across the enclosure 450 of the food processing device 402 below. Further, seasoning may be applied relatively quickly and evenly to the extent the metering device may rapidly disperse a plurality of discrete seasoning portions.

The discrete seasoning portion may be used to apply seasoning generally evenly upon food within the enclosure 450 of the food processing device 402. Merely by way of example, seasoning may be increased by cycling the device multiple times, thereby delivering additional discrete seasoning portions to the food. Alternatively, fewer cycles of the device, e.g., a single cycle, may be used to apply relatively less seasoning.

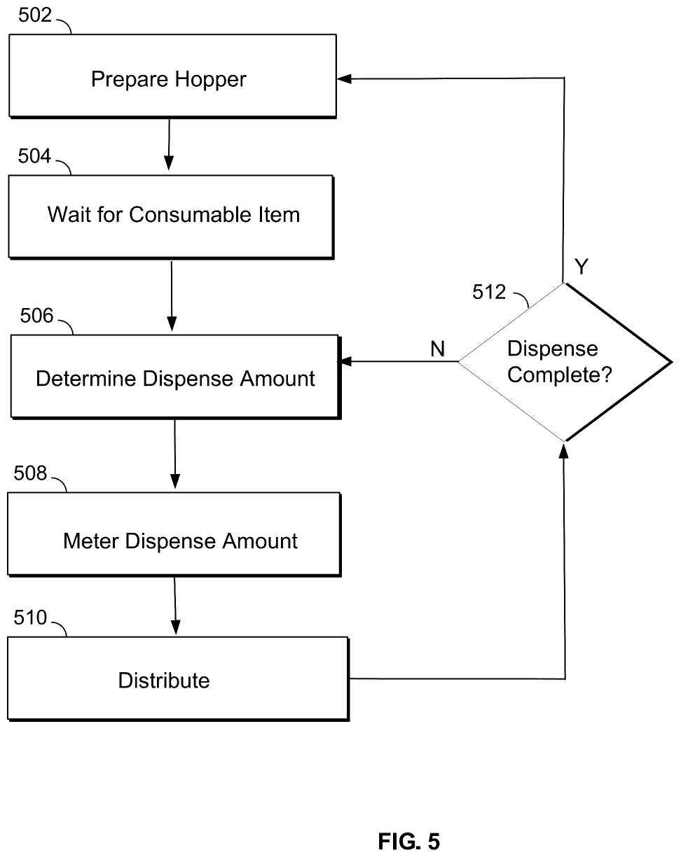

FIG. 5 depicts exemplary steps for dispensing seasoning in an automated food preparation system in accordance with some embodiments of the present disclosure. Although particular steps are depicted in a certain order for FIG. 5, steps may be removed, modified, or substituted, and additional steps may be added in certain embodiments, and in some embodiments, the order of certain steps may be modified. Although the steps of FIG. 5 may be described in the context of certain of the implementations discussed herein, it will be understood that these steps may be applied to all of the implementations disclosed in the present disclosure.

At step 502, a hopper may be prepared for dispensing of a seasoning. In the context of an automated food preparation system, a hopper may be a component of a seasoning dispensing apparatus that may be in communication with a control system and/or other components to identify when seasoning is to be dispensed. Further, hopper status may be periodically checked. The preparation of the hopper may include sub-steps such as monitoring a hopper to determine that adequate seasoning is present in the hopper, the proper hopper (e.g., including the proper seasoning(s)) is present, and other similar operations. If additional action is required, such as automatically filling or switching hoppers or notifying an operator of the need to do so, the seasoning dispensing apparatus may confirm that such action is complete before continuing to step 504. Once the hopper is ready for dispensing, processing may continue to step 504.

At step 504, the system may determine whether a consumable item is ready for dispensing of seasoning. For example, a consumable item may be partially prepared (e.g., by frying) and placed in a location suitable for dispensing from a seasoning dispensing apparatus (e.g., in an enclosure adjacent to or directly below the seasoning dispensing apparatus). Such placement may be determined in a variety of manners, such as by a control system of an automated food preparation system providing a notification to the seasoning dispensing apparatus (e.g., in response to other actions such as a robot arm dumping the contents of the fry basket into the enclosure, etc.), directly controlling the operation of the seasoning dispensing apparatus, and/or directly or indirectly sensing the consumable item within enclosure (e.g., via heat or proximity sensors of the enclosure or seasoning dispensing apparatus). The consumable item may also be associated with a particular dispensing protocol, based on factors such as the type of consumable item, particular recipes (e.g., how the consumable item will be prepared in later operations), or particular requests in customer orders. Once the consumable item is in the enclosure and any dispensing information specific to the consumable item is known, the processing may continue to step 506.

At step 506, the dispense amount may be determined. In some embodiments such as a high-volume system for a single type of consumable item (e.g., an automated system for french fries), a dispense amount may be predetermined and a consistent quantity of the consumable item may be delivered to the enclosure for seasoning, such that the dispense amount can simply repeated for each dispensing cycle. In instances where different consumable items or seasoning options are available, dispense amounts may be modified such as by performing multiple metering cycles for a single distribution cycle, having different sizes of metering pockets, repeating metering-distribution cycles, and the like. Once the dispense amount is determined, processing may continue to step 508.

At step 508, the dispense amount may be metered. Depending on the type of dispenser (e.g., adjacent horizontal dispenser, overhead radial dispenser, etc.) and metering configuration (e.g., offset rotating disk and wheel, linear articulating metering device, etc.), the metering device accesses and meters a discrete seasoning portion of the seasoning (e.g., that is gravity fed from a hopper) and provides the discrete seasoning portion to the distributor (e.g., a distributor paddle wheel or a radial distributor) for distribution onto the consumable items at the relevant location (e.g., in an enclosure). Processing may then continue to step 510.

At step 510, the seasoning may be distributed from the distributor. Although a variety of configurations of a distributor relative to consumable items is possible, in one example a distributor of a seasoning distributing apparatus may have a paddle wheel that rotates at a speed relative to a dispensing opening, which in turn causes the seasoning to dispense with a distribution horizontally over the consumable items. In some embodiments, the dispensing opening may be partially covered by a diffuser that supports a particular distribution pattern associated with the seasoning and consumable items. If a different pattern is required, diffusers may be swapped out automatically or an indication may be provided to an employee to change diffusers. In another example embodiment, the dispensing may be performed from an overhead dispenser, for example, a perforated radial distributor located above the consumable items (e.g., in the enclosure). Once the dispensing is performed, processing may continue to step 512.

At step 512, it may be determined whether the dispensing is complete. For example, in some instances another metering-distribution cycle may be performed to obtain a desired amount of seasoning. If multiple hoppers and seasonings are available, a hopper may be swapped out automatically (step not depicted in FIG. 5) and the metering and dispense cycle repeated. If an error occurs or if the seasoning did not properly dispense, in some instances the metering-distribution cycle may be repeated, for example, with a smaller discrete seasoning portion metered and distributed. If the dispensing is complete for the consumable item, processing may return to step 502 and processing may continue (e.g., with the seasoned consumable item being removed from the enclosure, not depicted in FIG. 5). If dispensing is to be continued for the particular consumable items, processing may return to step 506.

The foregoing is merely illustrative of the principles of this disclosure and various modifications may be made by those skilled in the art without departing from the scope of this disclosure. The embodiments described herein are provided for purposes of illustration and not of limitation. Thus, this disclosure is not limited to the explicitly disclosed systems, devices, apparatuses, components, and methods, and instead includes variations to and modifications thereof, which are within the spirit of the attached claims.

The systems, devices, apparatuses, components, and methods described herein may be modified or varied to optimize the systems, devices, apparatuses, components, and methods. Moreover, it will be understood that the systems, devices, apparatuses, components, and methods may have many applications such as monitoring of liquids other than water. The disclosed subject matter should not be limited to any single embodiment described herein, but rather should be construed according to the claims.

What is claimed is:

1. A seasoning dispensing apparatus, comprising:
a hopper including that holds a seasoning;
a metering device coupled below the hopper to receive the seasoning and to select a discrete seasoning portion of the seasoning from the hopper; and
a distributor coupled to the metering device to receive the discrete seasoning portion and to dispense the discrete seasoning portion outwardly from a distributor axis.

2. The seasoning dispensing apparatus of claim 1, wherein the distributor is stationary.

3. The seasoning dispensing apparatus of claim 1, further comprising a stationary support coupled to suspend the distributor at a predetermined height above an enclosure including a volume to contain a plurality of consumable items to be seasoned.

4. The seasoning dispensing apparatus of claim 3, wherein the enclosure regulates a temperature of air within the enclosure.

5. The seasoning dispensing apparatus of claim 1, wherein the distributor includes an angled surface about the distributor axis to spread the discrete seasoning portion radially outwardly with a radial spread of 360 degrees from the distributor axis.

6. The seasoning dispensing apparatus of claim 1, wherein the distributor includes a dispersion cone.

7. The seasoning dispensing apparatus of claim 1, wherein the distributor includes a vertex disposed below the metering device, the vertex containing the distributor axis, the distributor including a downwardly angled surface extending radially outwardly about the distributor axis.

8. The seasoning dispensing apparatus of claim 1, wherein the metering device includes a portioning plate having a cavity configured to receive the seasoning from the hopper, the cavity defining a volume corresponding to the discrete seasoning portion.

9. The seasoning dispensing apparatus of claim 8, wherein the portioning plate is restricted to a bidirectional movement to translate the cavity horizontally with respect to an outlet of the hopper.

10. The seasoning dispensing apparatus of claim 8, further comprising a stationary cover plate defining an opening, the stationary cover plate positioned above the portioning plate such that the opening is selectively located above the cavity.

11. The seasoning dispensing apparatus of claim 8, further comprising a solenoid configured to translate the portioning plate relative to the hopper.

12. The seasoning dispensing apparatus of claim 1, wherein the metering device is arranged above the distributor.

13. The seasoning dispensing apparatus of claim 12, wherein an outlet of the hopper is aligned with the distributor axis above the distributor.

14. The seasoning dispensing apparatus of claim 1, further comprising at least one securing feature configured to secure the seasoning dispensing apparatus to a food processing device.

15. The seasoning dispensing apparatus of claim 14, wherein the at least one securing feature includes a magnet.

16. An automated food preparation system, comprising:
a hopper including that holds a seasoning;
a metering device coupled below the hopper to receive the seasoning and to select a discrete seasoning portion of the seasoning from the hopper;
a distributor coupled to the metering device to receive the discrete seasoning portion and to dispense the discrete seasoning portion outwardly from a distributor axis; and
a food processing device located below the distributor.

17. The automated food preparation system of claim 16, wherein the food processing device comprises at least one enclosure configured to accommodate consumable items and wherein the at least one enclosure is coupled to an apparatus configured to regulate a material composition and temperature of air within the at least one enclosure.

18. A method of dispensing seasoning, the method comprising:
providing a seasoning in a hopper;
providing, by a metering device, a discrete seasoning portion of the seasoning to a distributor having a distributor axis; and
expelling the discrete seasoning portion with the distributor such that the discrete seasoning portion is spread radially outward from the distributor axis.

19. The method of claim 18, wherein feeding the discrete seasoning portion to the distributor comprises aligning a cavity of a portioning plate of the metering device with an aperture positioned above the distributor, the cavity defining a volume corresponding to the discrete seasoning portion.

20. The method of claim 19, further comprising guiding the discrete seasoning portion through the aligned cavity and aperture such that the discrete seasoning portion contacts a surface of the distributor.

21. The method of claim 18, wherein the metering device includes a reciprocating portioning plate defining a cavity having an interior volume corresponding to the discrete seasoning portion.

22. The method of claim 18, wherein the discrete seasoning portion is distributed from the distributor to a food processing device positioned below the distributor, further comprising regulating, by the food processing device, a material composition and temperature of air within at least one enclosure, wherein the at least one enclosure is configured to accommodate consumable items.
